(19) United States
(12) Patent Application Publication
(10) Pub. No.: US 2017/0301149 A1
(43) Pub. Date: Oct. 19, 2017

(54) PARKING ASSIGNMENT SYSTEM WITH LASER RANGEFINDER AND PARKING METER

(71) Applicant: Surespot, Inc., Houston, TX (US)

(72) Inventor: Omri Shafran, Houston, TX (US)

(73) Assignee: Surespot, Inc., Houston, TX (US)

(21) Appl. No.: 15/516,673

(22) PCT Filed: Oct. 5, 2015
(86) PCT No.: PCT/US15/54094

§ 371 Date: Apr. 4, 2017

Related U.S. Application Data
(60) Provisional application No. 62/066,867, filed on Oct. 21, 2014.
(60) Provisional application No. 62/059,850, filed on Oct. 3, 2014.

(51) Int. Cl. G07B 15/04; G06Q 20/18; G06Q 20/20; G08G 1/14

(52) U.S. Cl. CPC G07B 15/04; G08G 1/141; G06Q 20/18; G06Q 20/204; G06Q 2240/00

(57) ABSTRACT

A parking assignment system that comprises:
a parking assignment device;
a computer system running software comprising a parking assignment algorithm wherein the parking assignment algorithm is stored on a computer readable medium; and
a sensor;
wherein said computer system is in communication with said sensor;
wherein said computer system is in communication with said parking assignment device;
wherein said parking assignment algorithm is configured to optimally assign a parking space;
wherein said parking assignment device is configured to accept input that comprises data from said sensor and communicate said data from said sensor to said computer system;
wherein said computer system is configured to use said data from said sensor to track available parking spots; and
wherein said computer system is configured to accept input comprising a user's parking preferences and assign an optimal parking space according to said parking assignment algorithm.

This application claims the benefit of provisional patent applications 62/059,850 filed on 3 Oct. 2014, 62/066,867 filed on 21 Oct. 2014, and 62/068,608 filed on 24 Oct. 2014.

### BACKGROUND

The present invention relates generally to parking automobiles and more specifically to determining an optimal available parking space and communicating the parking space's location to a user.

### BRIEF DESCRIPTION OF DRAWINGS

FIG. 1 depicts an example of a parking assignment device that comprises a computer system running software comprising a parking assignment algorithm in an illustrative embodiment;

FIG. 2 depicts an example of a parking assignment device that comprises a magnetic card reader or barcode reader in an illustrative embodiment;

FIG. 3 depicts an example of a parking assignment device that comprises a transmission device to allow input or output of data between the parking assignment device and the barrier gate in an illustrative embodiment;

FIG. 4 depicts an example of a parking assignment device that comprises one or more user interface devices in an illustrative embodiment;

FIG. 5 depicts an example of a parking assignment device that comprises a printer or barcode reader in an illustrative embodiment;

FIG. 6 illustrates a flow diagram describing a parking assignment process in an illustrative embodiment;

FIG. 7 illustrates a flow diagram describing a parking assignment process in an illustrative embodiment;

FIG. 8 depicts an example of a barrier gate viewed from the front in an illustrative embodiment; and

FIG. 9 depicts an example of a barrier gate viewed from the side in an illustrative embodiment.

FIG. 10 depicts an example of a laser rangefinder connected to a pan and tilt mount viewed from the side in an illustrative embodiment.

FIG. 11 depicts an example of a laser rangefinder connected to a pan and tilt mount viewed from the front in an illustrative embodiment.

FIG. 12 depicts an example of a laser rangefinder connected to a pan and tilt mount viewed from the rear in an illustrative embodiment.

FIG. 13 depicts an example of a laser rangefinder connected to a pan and tilt mount viewed orthogonally in an illustrative embodiment.

FIG. 14 depicts an example of a laser rangefinder viewed from the rear in an illustrative embodiment.

FIG. 15 depicts an example of a laser rangefinder viewed from the side in an illustrative embodiment.

FIG. 16 depicts an example of a laser rangefinder viewed from the front in an illustrative embodiment.

FIG. 17 depicts an example of a laser rangefinder viewed orthogonally in an illustrative embodiment.

FIG. 18 depicts an example of a laser rangefinder connected to a pan and tilt mount viewed orthogonally in an illustrative embodiment wherein the pan and tilt mount is attached to a light pole in a parking lot.

FIG. 19 depicts an example of a pan and tilt mount viewed from the front, side, top, and orthogonally in an illustrative embodiment.

FIG. 20 depicts an example of a laser rangefinder viewed from the side, top, and orthogonally in an illustrative embodiment.

FIG. 21 depicts an example of a laser rangefinder connected to a pan and tilt mount viewed from the front, side, top, and orthogonally in an illustrative embodiment.

FIG. 22 depicts an example of a laser rangefinder connected to a pan and tilt mount viewed orthogonally in an illustrative embodiment wherein the pan and tilt mount is attached to a light pole.

FIG. 23 depicts an embodiment of a parking assignment device that is a parking meter.

FIG. 24 depicts an embodiment of a parking assignment device that is a parking meter.

### DETAILED DRAWING DESCRIPTIONS

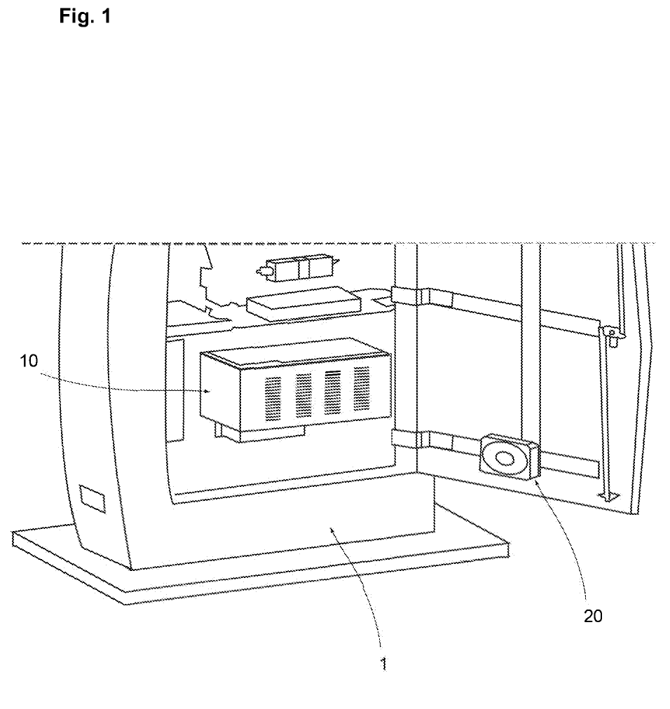

FIG. 1 depicts an embodiment of a parking assignment device 1 that comprises a computer system 10 running software comprising a parking assignment algorithm. The parking assignment algorithm is stored on a computer readable medium. Cooling fans 20 cool the computer system. The computer system 10 may alternatively or additionally be connected via internet or other data connection to a computer system or server running a parking assignment algorithm. The parking assignment algorithm is configured to optimally assign parking spaces to users, based on which available parking space is best for each user. The computer system 10 accepts input from one or more sources which may comprise user preferences, tracked available parking spots, sensors, or cameras or rangefinders. For example, if a user indicates a desire to shop at a particular store in a large mall, the parking assignment algorithm can receive camera data input or distance data input to determine which parking spots are available and select an available parking space that is near that store's entrance.

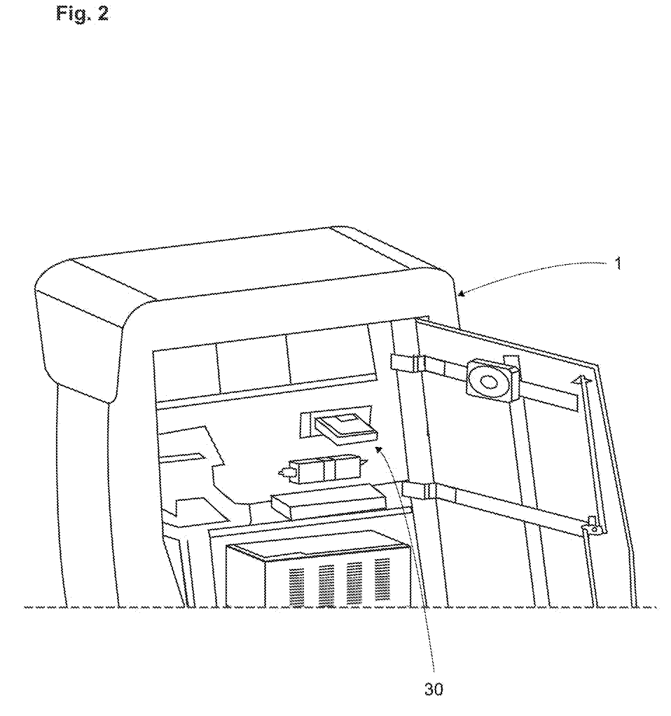

FIG. 2 depicts an embodiment of a parking assignment device 1 that comprises a card reader 30. The card reader 30 may comprise a magnetic card reader. Further embodiments of a parking assignment device 1 may comprise an input device, wherein the input device may comprise a barcode or matrix code reader (e.g. quick response code reader), a radio-frequency identification card reader, a magnetic strip reader, a proximity sensor, or other input device.

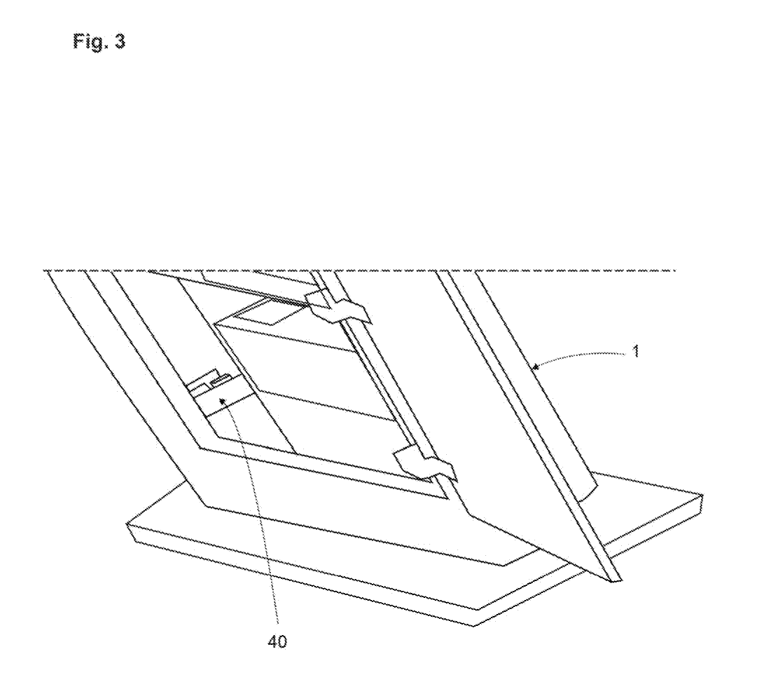

FIG. 3 depicts an embodiment of a parking assignment device 1 that comprises a transmission device 40 to allow input or output of data between the parking assignment device 1 and the barrier gate (not shown). A transmission device may comprise an electronic module for radio frequency communication.

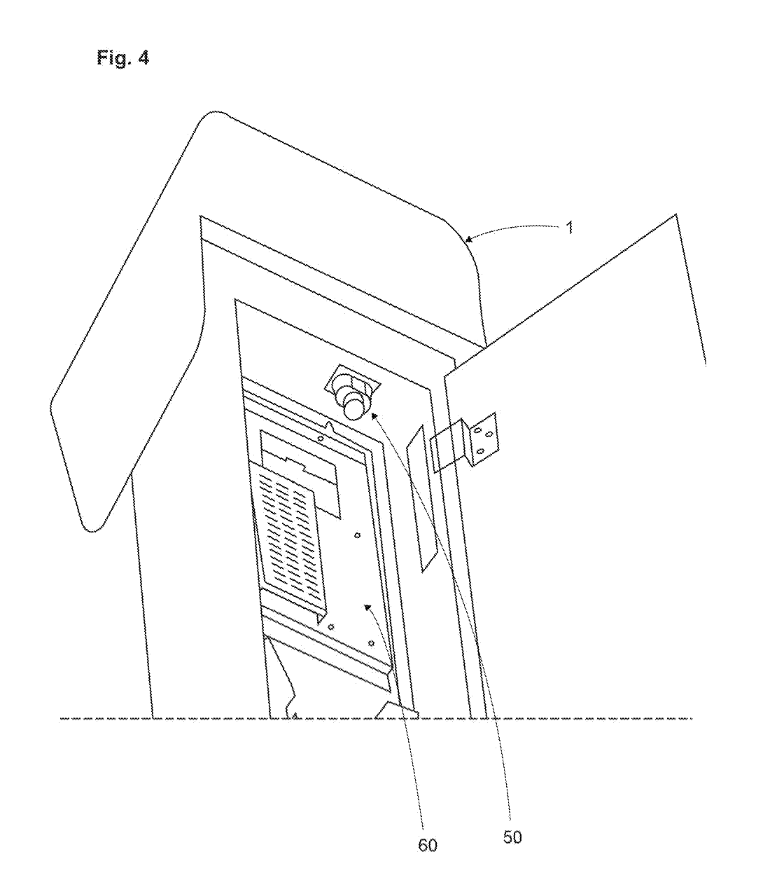

FIG. 4 depicts an embodiment of a parking assignment device 1 that comprises a speaker 50 and a touchscreen monitor 60. Other embodiments could have different configurations of user interface devices to receive input from a user or to send output to a user. Examples of user interface devices comprise: a microphone, a non-touchscreen monitor, a keypad, a keyboard, and a biometric sensor.

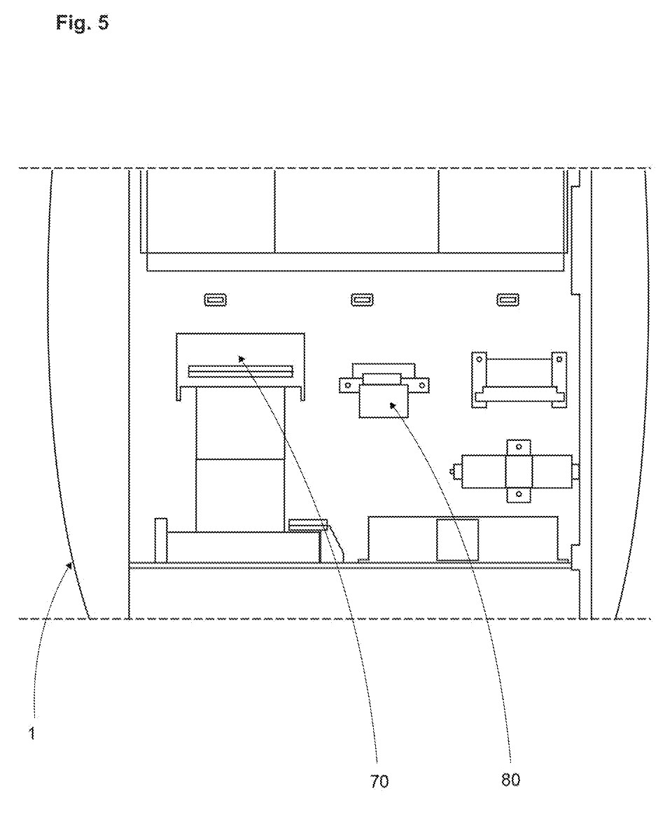

FIG. 5 depicts an embodiment of a parking assignment device 1 that comprises a thermal paper printer 70 and a barcode reader 80. It should be appreciated that other types of printers or readers could also be used.

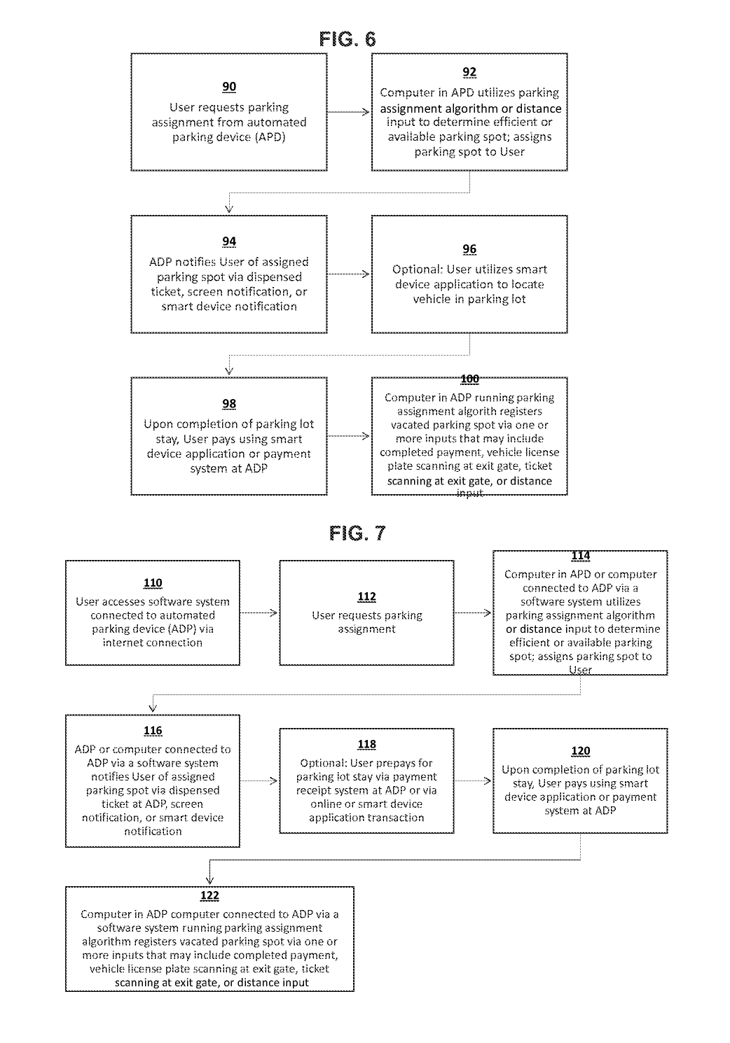

FIG. 6 illustrates a flow diagram describing a parking assignment process in an exemplary embodiment.

At step 90, an automated parking system's computer system receives a parking assignment request from a user.

At step 92, the automated parking system's computer system receives distance input from a rangefinder for determining available parking spaces and uses a parking assignment algorithm to determine an optimal available parking spot and assigns the parking spot to the user.

At step 94, the automated parking system notifies the user of the assigned parking spot via dispensed ticket, screen notification, or smart device notification.

At optional step 96, a smart device application shows the user's vehicle location in the parking lot.

At step 98, upon completion of parking lot stay, the automated parking system receives payment from the user. Optionally, payment is received via a smart device application.

At step 100, the automated parking system's computer system, running software comprising a parking assignment algorithm, registers the vacated parking spot via one or more inputs that may comprise completed payment, vehicle license plate scanning at the exit gate, ticket scanning at exit gate, or distance data input from a rangefinder that has a view of the parking spot.

FIG. 7 illustrates a flow diagram describing a parking assignment process in an illustrative embodiment.

At step 110, a computer system running parking assignment software comprising a parking assignment algorithm connects to an automated parking device via internet connection.

At step 112, the computer system receives a request for a parking assignment.

At step 114, the computer system using the parking assignment algorithm receives distance data input to determine which parking spaces are unoccupied and determines an optimal available parking spot and assigns the parking spot to a user.

At step 116, the computer system notifies the user of the assigned parking spot via dispensed ticket at automated parking device, screen notification, or smart device notification.

At optional step 118, the computer system receives prepayment for parking lot stay via payment receipt system at automated parking device or via online or smart device application transaction.

Alternatively, at step 120, the computer system receives payment after parking lot stay via payment receipt system at automated parking device or via online or smart device application transaction.

At step 122, the computer system registers vacated parking spot via one or more inputs that may comprise:completed payment, vehicle license plate scanning at exit gate, ticket scanning at exit gate, or distance data input.

The flow diagrams depicted herein are examples. There may be many variations to these diagrams or the steps (or operations) described therein without departing from the spirit of the invention. For instance, the steps may be performed in a differing order or steps may be added, deleted or modified. All of these variations are considered a part of the claimed invention.

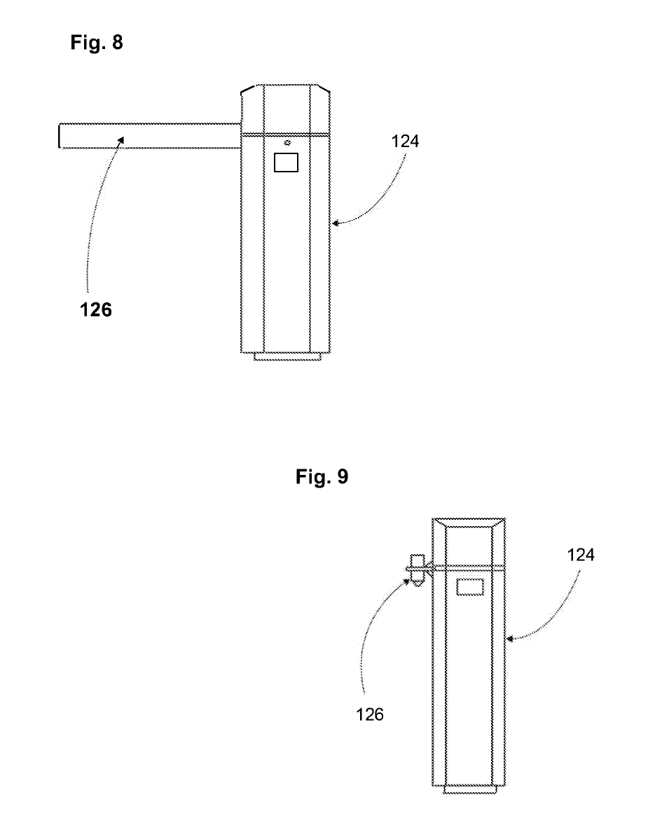

FIG. 8 depicts an embodiment of a barrier gate 124 with a rotatably attached gate arm 126 viewed from the front. The barrier gate 124 can receive signals from the automated parking device's transmission device 40.

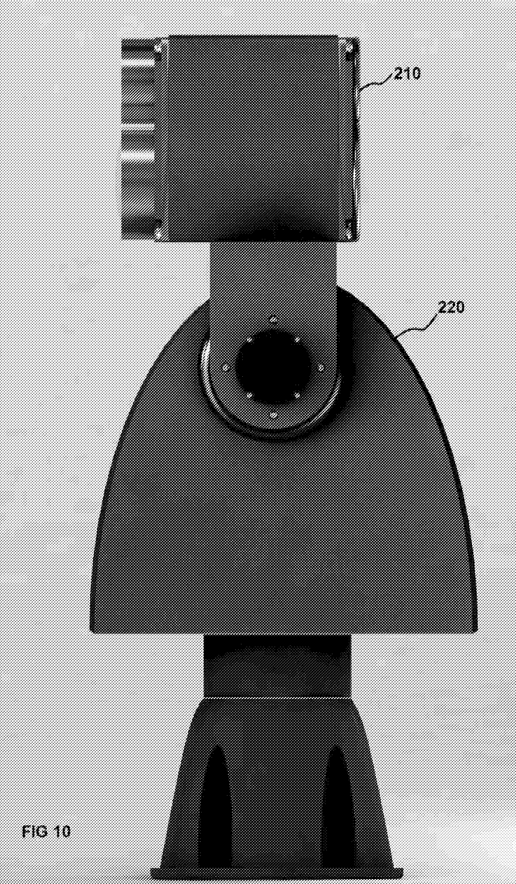

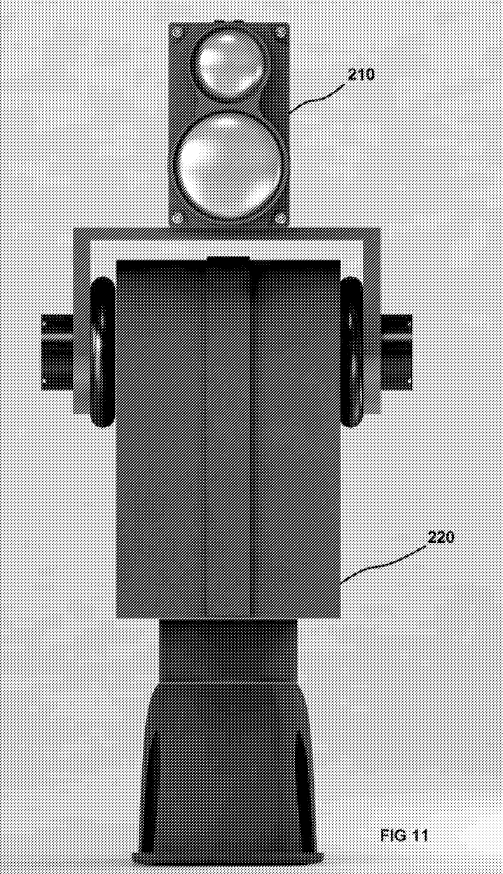

FIG. 9 depicts an embodiment of a barrier gate 124 with a rotatably attached gate arm 126 viewed from the side. The barrier gate 124 can receive signals from the automated parking device's transmission device 40.

Certain embodiments can comprise computer program code containing instructions embodied in tangible media, such as, CD-ROMs or similar type discs, hard drives, or another computer-readable storage medium. If the computer program code is transferred to and executed by a computer, the computer becomes an apparatus for practicing the invention. An embodiment can comprise computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention.

FIG. 10 depicts an example of a laser rangefinder 210 connected to a pan and tilt mount 220 viewed from the side in an illustrative embodiment. The laser rangefinder 210 can collect distance data as it scans parking spaces. Because the distance from the laser rangefinder 210 to a vehicle parked in a parking space is shorter than the distance from the laser rangefinder 210 to the surface of the parking space, distance data is indicative of whether a vehicle is parked in a given parking space. Laser rangefinder 210 is attached to pan and tilt mount 220. Pan and tilt mount 220 moves laser rangefinder 210 so that its orientation changes over time and the laser beam projected by laser rangefinder 210 traverses a plurality of parking spaces, and laser rangefinder 210 collects distance data for each parking space traversed by its beam. For certain embodiments, collected distance data is transmitted to a computer system 10 that executes software comprising a parking space assignment algorithm.

FIG. 11 depicts an example of a laser rangefinder 210 connected to a pan and tilt mount 220 viewed from the front in an illustrative embodiment.

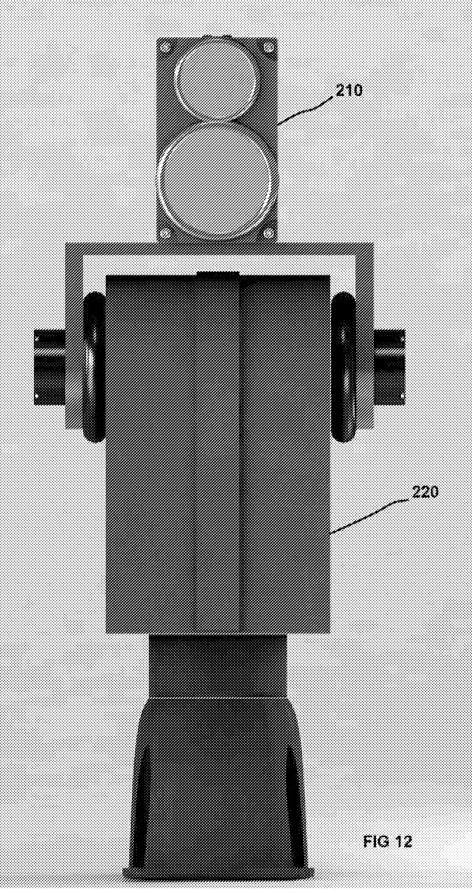

FIG. 12 depicts an example of a laser rangefinder 210 connected to a pan and tilt mount 220 viewed from the rear in an illustrative embodiment.

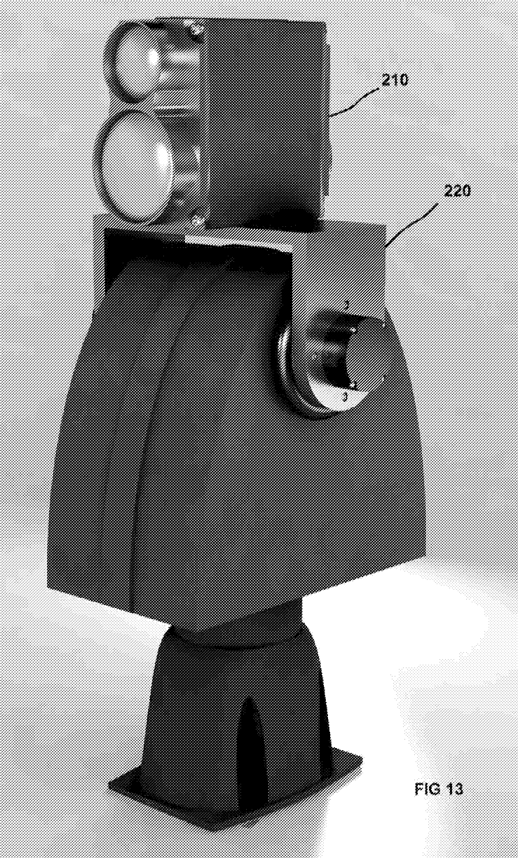

FIG. 13 depicts an example of a laser rangefinder 210 connected to a pan and tilt mount 220 viewed orthogonally in an illustrative embodiment.

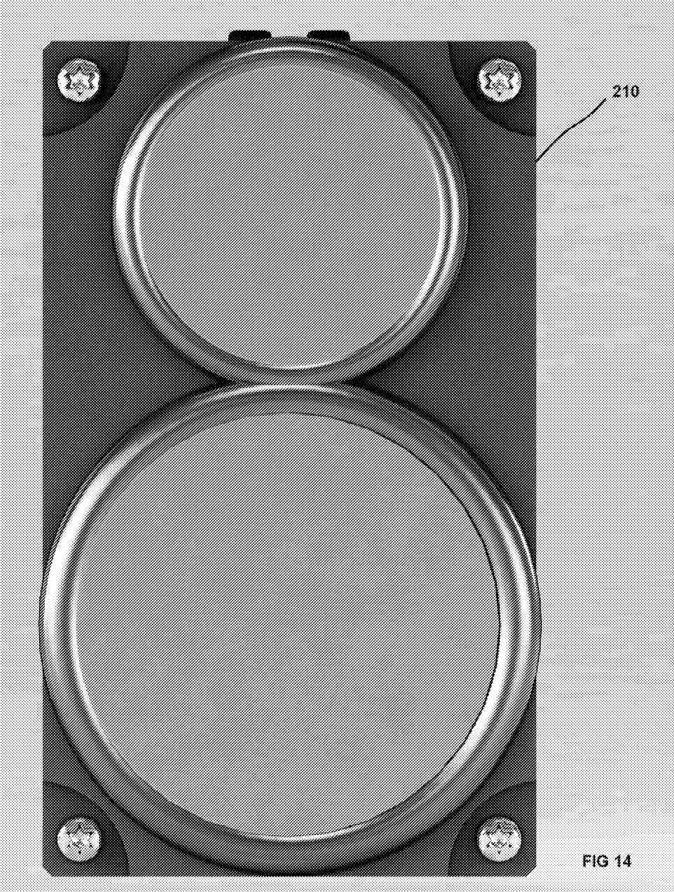

FIG. 14 depicts an example of a laser rangefinder 210 viewed from the rear in an illustrative embodiment. Said rangefinder's distance measurements should be sufficiently precise to discern occupied spaces from unoccupied spaces.

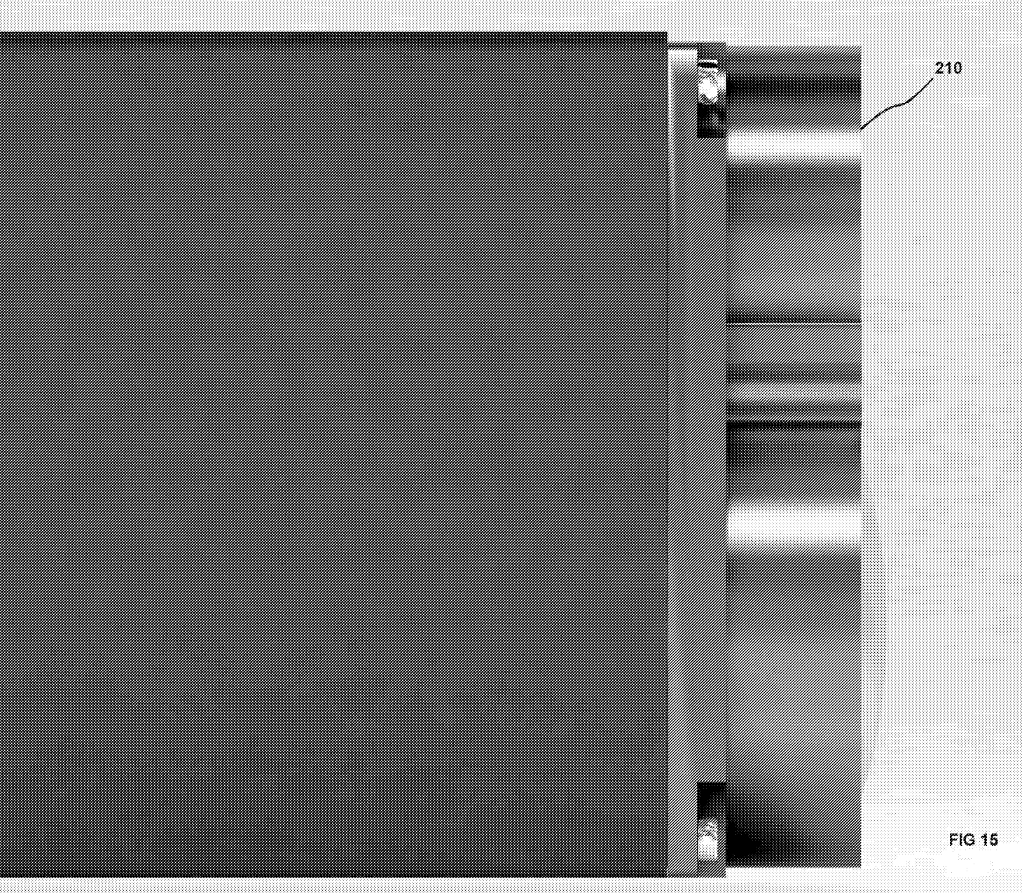

FIG. 15 depicts an example of a laser rangefinder 210 viewed from the side in an illustrative embodiment.

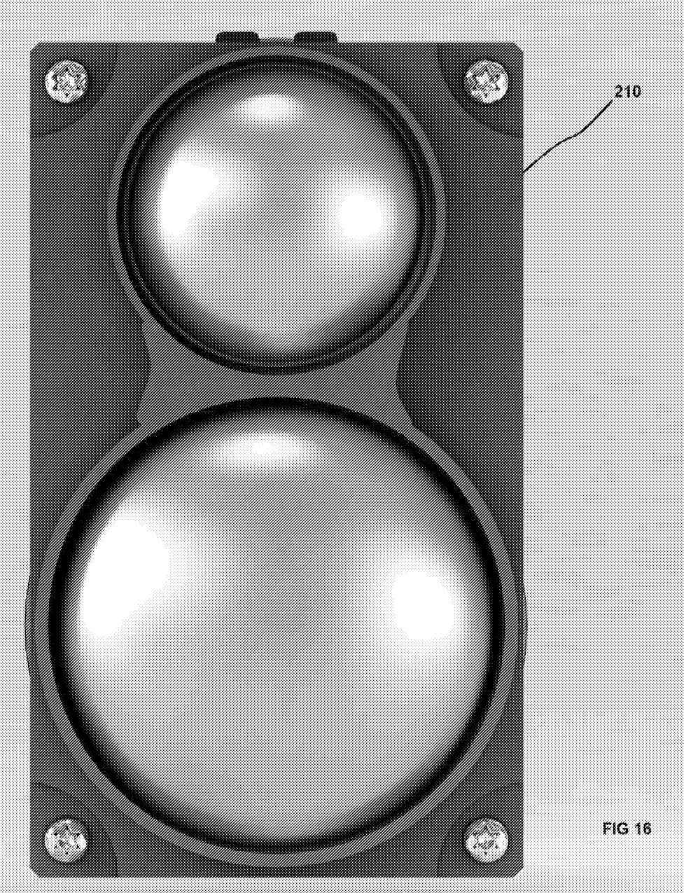

FIG. 16 depicts an example of a laser rangefinder 210 viewed from the front in an illustrative embodiment.

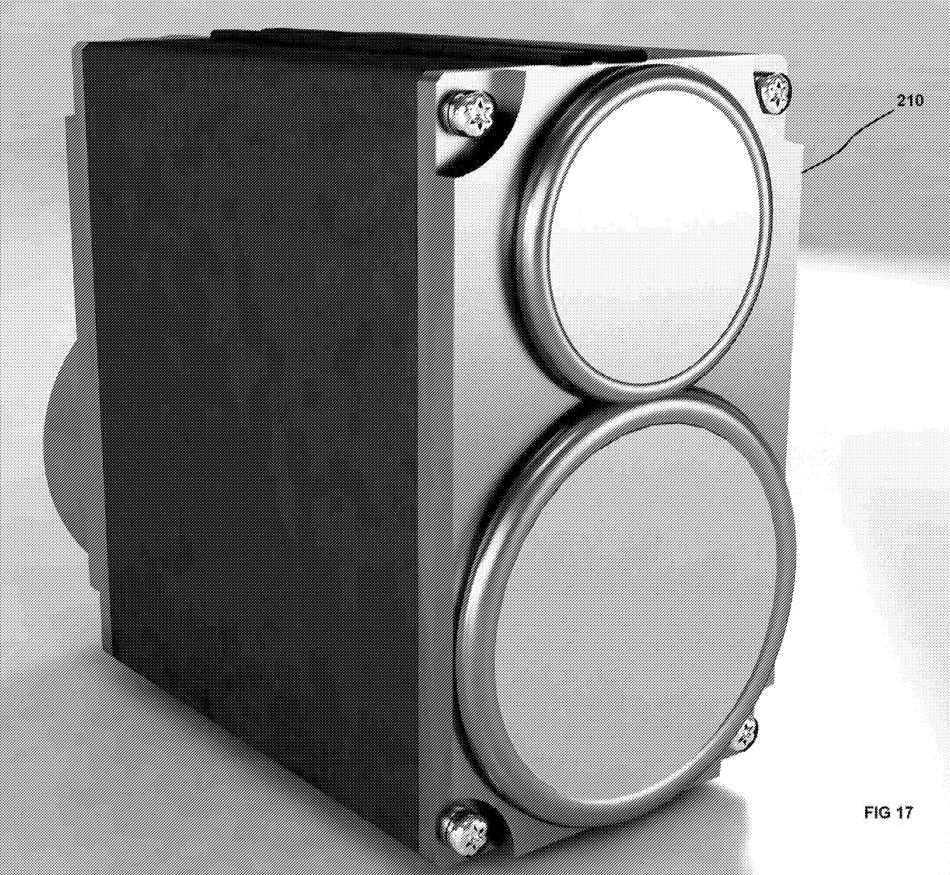

FIG. 17 depicts an example of a laser rangefinder 210 viewed orthogonally in an illustrative embodiment.

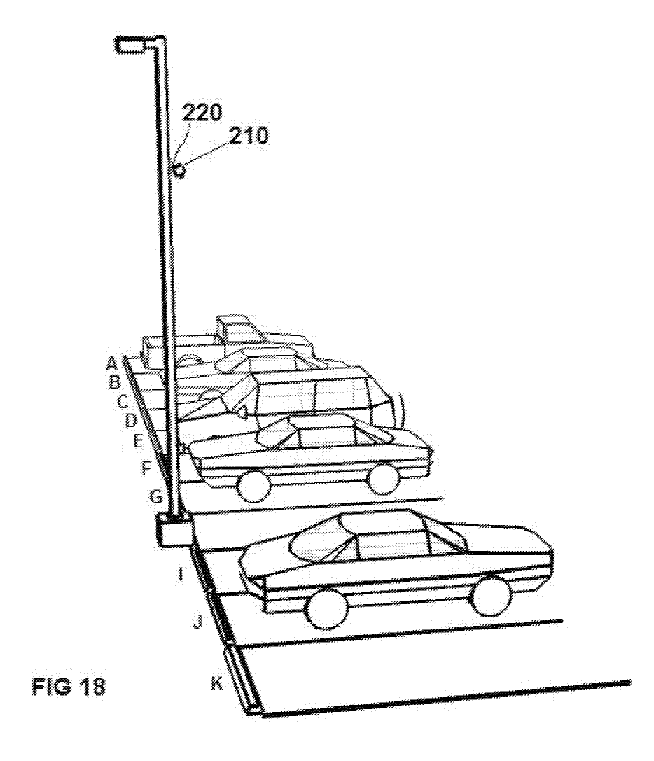

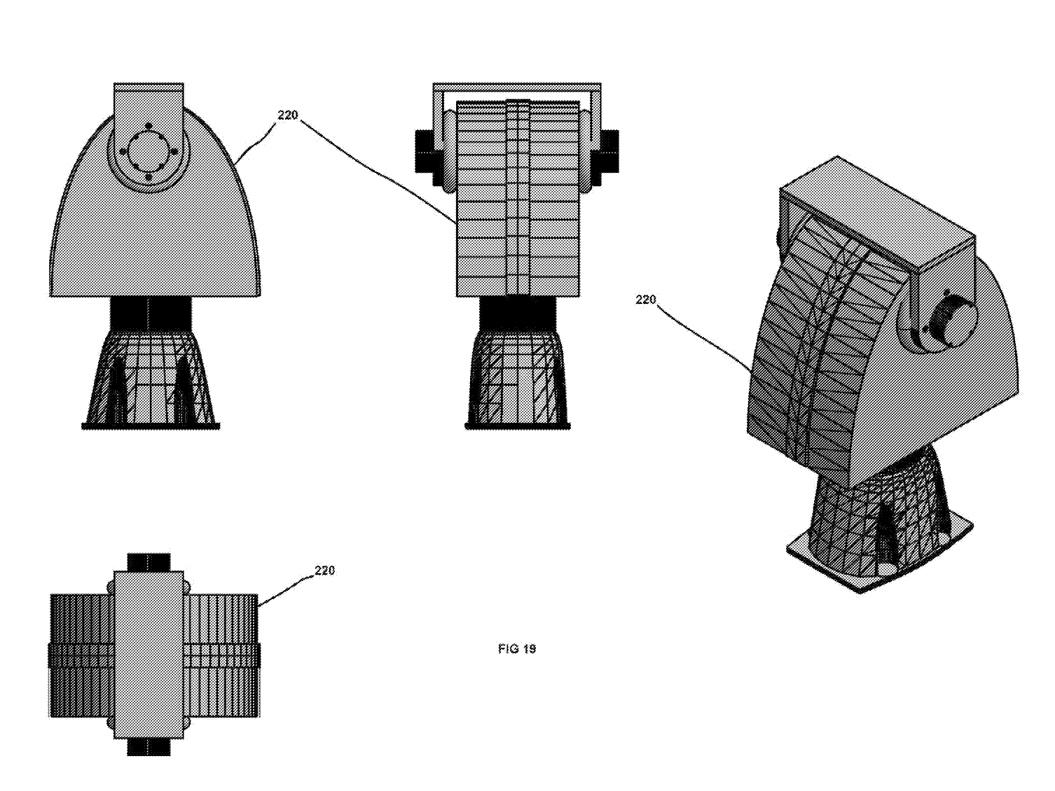

FIG. 18 depicts an example of a laser rangefinder 210 connected to a pan and tilt mount 220 viewed orthogonally in an illustrative embodiment wherein the pan and tilt mount is attached to a light pole in a parking lot. In accordance with an embodiment, pan and tilt mount 220 directs the path of the laser rangefinder's laser beam across parking spaces A through K. Rangefinder 210 measures distances as its beam traverses the parking spaces. When the beam reflects off of a parked car the measured distance is shorter than the distance measured when the parking space is empty. Thus, when the distance data collected by the rangefinder 210 is transmitted to a computer system 10, the distance data can be input into a parking space assignment algorithm as an indication of which spaces are empty and which spaces are occupied, and the parking space assignment algorithm can assign unoccupied spaces. When laser rangefinder 210 collects distance data for parking space J, the distance measured is less than the distance from the rangefinder 210 to the surface of parking space J, so a parking space assignment algorithm will categorize parking space J as an occupied space. When laser rangefinder 210 collects distance data for parking space K, the distance measured matches the distance from the rangefinder 210 to the surface of parking space J, so a parking space assignment algorithm will categorize parking space K as an unoccupied space, so that when other factors make parking space K the most favored available parking space it will be assigned.

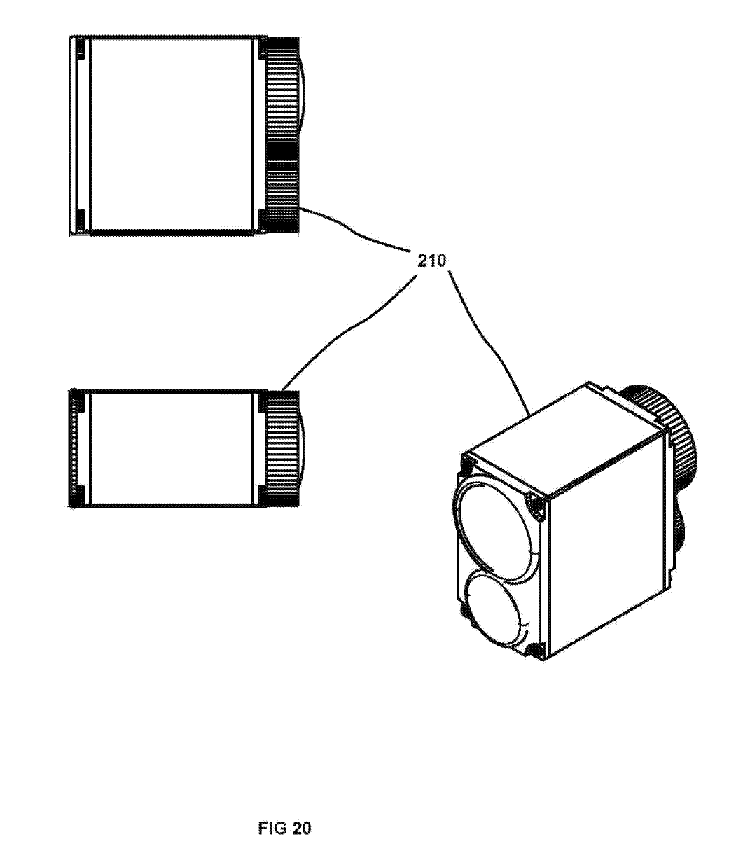

FIG. 19 depicts an example of a pan and tilt mount 220 viewed from the front, side, top, and orthogonally in an illustrative embodiment. Pan and tilt mount 220 will preferably provide sufficient range of motion so that as many parking spaces as practical may be scanned by rangefinder 210. Said pan and tilt mount's motion should be sufficiently precise and repeatable that said rangefinder's beam alignment with particular parking spaces when taking distance measurements remains consistent for many scans.

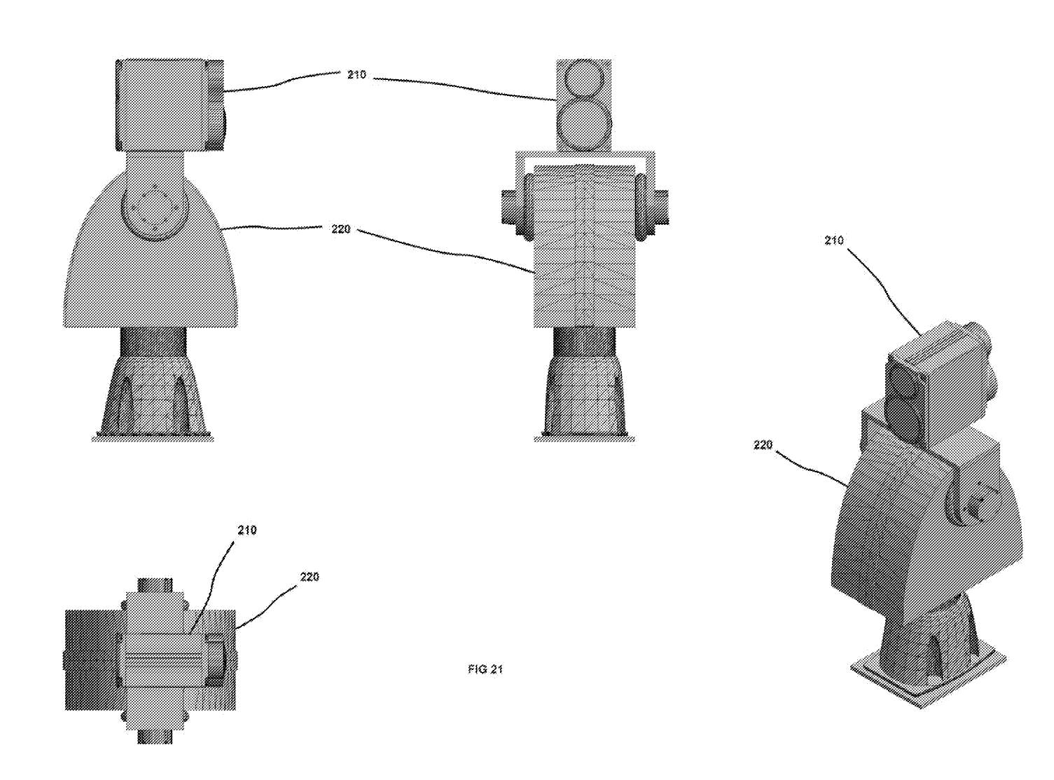

FIG. 20 depicts an example of a laser rangefinder 210 viewed from the side, top, and orthogonally in an illustrative embodiment.

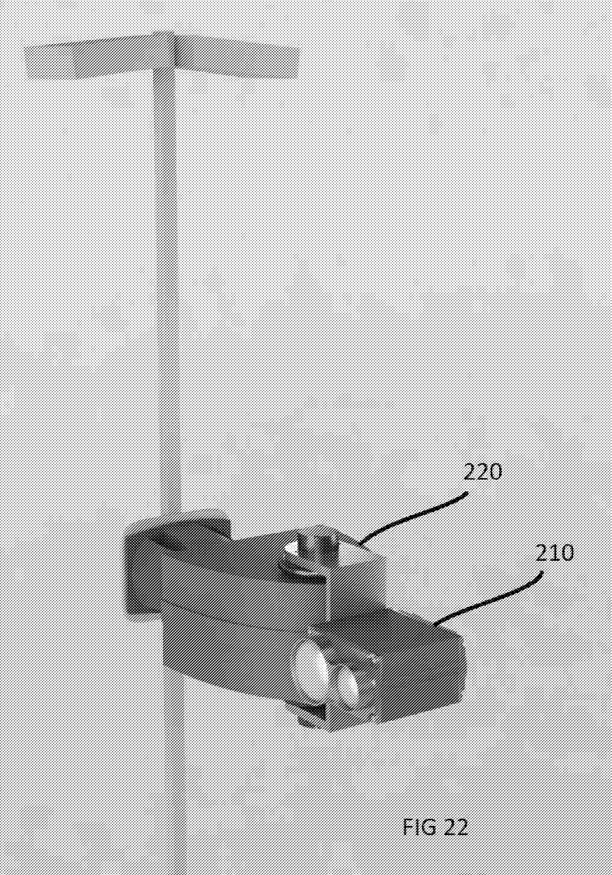

FIG. 21 depicts an example of a laser rangefinder 210 connected to a pan and tilt mount 220 viewed from the front, side, top, and orthogonally in an illustrative embodiment.

FIG. 22 depicts an example of a laser rangefinder 210 connected to a pan and tilt mount 220 viewed orthogonally in an illustrative embodiment wherein the pan and tilt mount is attached to a light pole. Preferably, rangefinder 210, connected to pan and tilt mount 220, will be mounted in a location that provides line of sight view of a maximum number of parking spaces, and such a location will often be well above the surface of the parking spaces. The mounting location should also be where the lines of sight to the parking spaces are not blocked by structures or vegetation. Tall poles and buildings will often be suitable mounting locations.

A parking assignment system can comprise a parking assignment device 1 that is a kiosk. In accordance with an embodiment a kiosk 1 can comprise:
a touch screen 60;
a matrix barcode reader 80;
a laser rangefinder;
a speaker 50;
a computer system 10 mounted within the kiosk 1, wherein the touch screen, matrix barcode reader 80, laser rangefinder, and speaker 50 are connected to the kiosk's computer system 10; and

a connection to a network that allows the kiosk's computer system 10 to send and receive signals over the network.

An embodiment can comprise a parking assistance device that serves as an on-street parking meter. Said parking meter could comprise a code reader, such as a QR reader, a printer, a computer system that runs software allowing a customer to pay using a computer or mobile device application, a screen which could be a touch screen, one or more laser rangefinders that have a view of parking spaces. The software running on the computer system could be used to determine available parking spaces and communicate this information to users by sending the information to the customer's mobile device or showing the information on the parking assistance device's screen.

For an embodiment comprising a parking assistance device that serves as a parking meter, the parking meter could be mounted on the ground or on a light pole or wall.

A parking assistance device that serves as a parking meter could further comprise power ports and related hardware to enable charging electric vehicles. Hardware to enable charging electric vehicles could comprise solar panels.

An example parking assignment system can comprise a parking meter 1 having a touch screen and a plurality of laser rangefinders with views of on-street parking spaces mounted above the parking meter and solar panels mounted above the laser rangefinders, wherein the solar panels provide power to the laser rangefinders and the parking meter 1.

For an embodiment comprising a parking meter 1 and a computer system 10 running software, laser rangefinders with a view of on-street parking spaces can send parking space distance data to the computer system 10. When a vehicle parks in the parking space, a camera can transmit an image showing the vehicle's license plate to the computer system 10 running the software. An example of a method by which an image could be transmitted is wireless transmission to the cloud. The software can use a license plate recognition algorithm to determine the vehicle's license plate number and record the time that the vehicle parked in the parking space. The parking meter 1 can accept payment for parking. Payment can also be made via a mobile device application.

In an example embodiment, a computer system 10 running software that evaluates laser rangefinder data could determine where available on-street parking can be found and transmit location information to users via the internet or cellular networks. A user could access available on-street parking information data via a website or a mobile device application. In an example embodiment, a computer system 10 running software that evaluates laser rangefinder data could determine when a vehicle has stayed in a parking space for longer than the paid time period. Optionally, the system could transmit a notification to the user that the paid time period is about to expire or has already expired.

Optionally, the system could send a notification to parking enforcement authorities that a parking infraction has occurred.

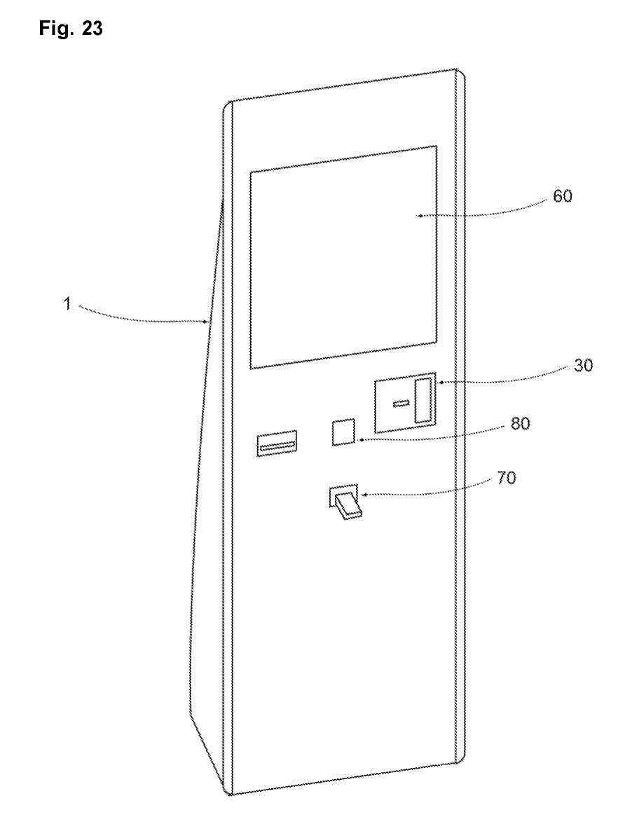

FIG. 23 depicts an embodiment of a parking assignment system comprising a parking assignment device 1 that is a parking meter The parking assignment system further comprises a computer system 10 running software comprising a parking assignment algorithm. The parking assignment algorithm is stored on a computer readable medium. The parking assignment device can have a cooling system comprising an air conditioner or one or more cooling fans 20 to cool the computer system. The computer system 10 may alternatively or additionally be connected via internet or other data connection to another computer system or server running a parking assignment algorithm. The parking assignment algorithm is configured to optimally assign parking spaces to users, based on which available parking space is best for each user. The computer system 10 accepts input from one or more sources. Input may comprise user preferences, tracked available parking spots, sensors, or cameras or rangefinders. For example, if a user indicates a desire to shop at a particular store in a large mall, the parking assignment algorithm can receive camera data input or laser rangefinder distance data input to determine which parking spots are available and select an available parking space that is near that store's entrance.

The embodiment of a parking meter 1 shown in FIG. 23 comprises a card reader 30. The parking meter 1 further comprises an input device 80, wherein the input device 80 may comprise a barcode reader or a matrix code reader (e.g. quick response code reader), a radio-frequency identification card reader, a magnetic strip reader, a proximity sensor, or other input device. The illustrated embodiment of a parking meter 1 comprises a touchscreen monitor 60. Other embodiments could have different configurations of user interface devices to receive input from a user or to send output to a user. Examples of user interface devices comprise: a microphone, a non-touchscreen monitor, a keypad, a keyboard, and a biometric sensor. An embodiment of a parking meter 1 could receive input via network from a user's mobile device. The illustrated example of a parking meter 1 comprises a thermal paper printer 70 and a barcode reader 80. It should be appreciated that other types of printers or readers could also be used.

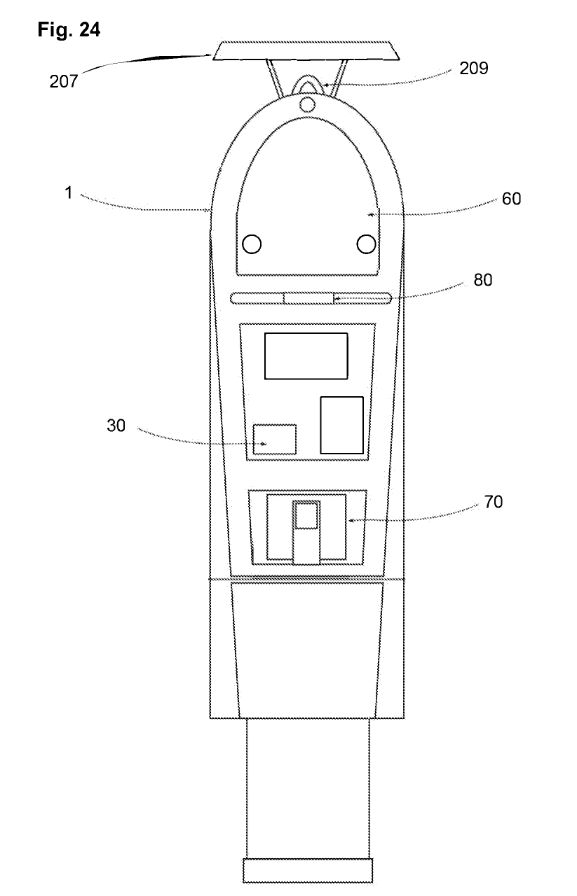

FIG. 24 depicts an embodiment of a parking assignment device 1 that is a parking meter. The example parking meter 1 comprises touch screen 60, a camera 209 mounted above the parking meter 1, and a solar panel 207 mounted above the camera 209, wherein the solar panel 207 provides power to the camera 209 and the parking meter 1. The example parking meter 1 comprises a matrix code reader 80, a card reader 30, and a printer 70.

A Quick Response (QR) barcode reader is an example of a matrix barcode reader 80.

Examples of a connection to a network can comprise: a Wireless Local Area Network connection (e.g. Wi-Fi), a Cellular network connection, or a wired network connection (e.g. ethernet).

A parking assignment system in accordance with an embodiment may further comprise an alarm system. In some embodiments the alarm system can be connected to the kiosk's computer system 10 or directly to the network and can send a signal if the kiosk 1 is opened or damaged.

A parking assignment system in accordance with an embodiment may further comprise a cooling system. A cooling system can comprise fans 20 or an air conditioner situated at the bottom of the kiosk 1.

A parking assignment system's kiosk 1, in accordance with an embodiment, may further comprise a printer 70 that is connected to the kiosk's computer system 10.

A parking assignment system in accordance with an embodiment may further comprise a gate barrier that selectively restricts entry or exit. The gate barrier can be connected to the kiosk's computer system 10 by a transmission device 40. The gate barrier can be connected to the network, through which the gate barrier receives signals instructing the gate barrier to allow or deny entry or exit. For example, entry may be denied when the lot is full or exit may be denied if vehicle occupants have not yet paid for parking. The gate barrier can optionally be connected to the alarm system so that a signal can be sent if the gate barrier is damaged.

A parking assignment system in accordance with an embodiment may further comprise an infrared beam positioned such that each vehicle that approaches the parking lot's entrance will break the infrared beam. When the infrared beam is broken the kiosk's computer system 10 receives a signal and, in response, the kiosk's computer system 10 sends a signal to the gate barrier and the gate barrier moves to permit vehicle entry.

A gate barrier in accordance with an embodiment can optionally comprise a screen onto which advertisements or directions are projected to be viewed by vehicle occupants. The screen can be connected to the network and the images shown on the screen can be sent through the network. Images shown on the screen can be tailored to occupants of particular vehicles. For example, the screen can be used to notify vehicle occupants that that they have won VIP parking, coupons, free parking for their next visit, or other prizes. The screen can notify vehicle occupants that a nearby retailer is having a sale. The screen can also be used to show vehicle occupants the way to their parking space.

An embodiment can comprise eTickets or printed tickets that can optionally comprise coupons for use at nearby retailers.

A parking space assignment system according to an embodiment may either assign a parking space on demand when a vehicle arrives or reserve a parking space in advance for a vehicle that has not yet arrived.

An embodiment can comprise a method of parking space assignment on demand comprising:
after a vehicle arrives at the kiosk 1, the kiosk's computer system 10 receives input from the touchscreen;
the kiosk's computer system 10 selects an available parking space and generates directions to the available parking space;
the kiosk 1 transmits an eTicket for the parking space or prints a paper ticket for the parking space;
a camera generates a digital image of the vehicle's license plate;
a license plate tracking system receives the digital image of the vehicle's license plate and recognizes the license plate number;
the license plate tracking system logs entry of the vehicle with the recognized license plate number; and
the license plate tracking system tracks the vehicle to the parking space.

An embodiment can comprise a method of assigning and reserving a parking space in advance comprising:
the parking assignment system receives a parking space reservation request;
the parking assignment system sends an eTicket to a vehicle occupant, wherein eTicket comprises a matrix barcode;
after a vehicle arrives at the kiosk 1 and a vehicle occupant presents the eTicket, the matrix barcode reader 80 reads eTicket's matrix barcode;
the kiosk's computer system 10 generates and transmits directions to the reserved parking space;

a camera generates a digital image of the vehicle's license plate;
a license plate tracking system receives the digital image of the vehicle's license plate and recognizes the license plate number;
the license plate tracking system logs entry of the vehicle with the recognized license plate number; and
the license plate tracking system tracks the vehicle to the reserved parking space.

A license plate recognition system can optionally be used to identify a vehicle's make. For example, the vehicle's trade dress could be recognized by the license plate recognition system, thereby identifying the automaker that produced the vehicle. This feature could enable a sponsor to provide some special benefit to occupants of a vehicle made by a particular automaker. A special benefit could comprise VIP parking or a coupon.

A parking assignment system could further comprise digital signs or a laser projector that shows a driver the way to a parking space.

A parking assignment system could further comprise cameras that transmit images of parked vehicles' license plates to the license plate recognition system, thereby enabling determination of which vehicle is in each parking space. An embodiment having this feature can provide vehicle occupants with directions to any parked vehicle, even if the driver did not park in the designated spot.

An embodiment can comprise a camera co-mounted with a laser rangefinder, wherein the laser rangefinder is programmed to track the vehicle to the parking space and the co-mounted camera sends images of the vehicle's license plate to the license plate recognition system. Such an embodiment can track which vehicle goes to each parking spot.

An embodiment of a parking assistance system comprises software that controls the system's hardware. The software, for example, controls when gates are opened, monitors lots, and uses license plate recognition to identify unauthorized vehicles. The software can monitor kiosks 1 to determine when printer paper must be replaced and when cash should be collected from kiosks 1.

In accordance with an embodiment, any or all of a computer system's components may reside inside of a parking assignment device or elsewhere.

What is claimed is:

1. A parking assignment system that comprises:
a parking assignment device;
a computer system running software comprising a parking assignment algorithm wherein the parking assignment algorithm is stored on a computer readable medium; and
a sensor;
wherein said computer system is in communication with said sensor;
wherein said computer system is in communication with said parking assignment device;
wherein said parking assignment algorithm is configured to optimally assign a parking space;
wherein said parking assignment device is configured to accept input that comprises data from said sensor and communicate said data from said sensor to said computer system;
wherein said computer system is configured to use said data from said sensor to track available parking spots; and
wherein said computer system is configured to accept input comprising a user's parking preferences and assign an optimal parking space according to said parking assignment algorithm.

2. The parking assignment system of claim 1 where a user's parking preferences comprise proximity to a location.

3. The parking assignment system of claim 1 further comprising a card reader wherein said computer system is in communication with said card reader.

4. The parking assignment system of claim 1 further comprising an input device wherein said computer system is in communication with said input device.

5. The parking assignment system of claim 4 wherein the input device comprises a matrix code reader.

6. The parking assignment system of claim 4 wherein the input device comprises a radio-frequency identification card reader.

7. The parking assignment system of claim 4 wherein the input device comprises a proximity sensor.

8. The parking assignment system of claim 1 a barrier gate wherein said computer system is in communication with said barrier gate and wherein said computer system is configured to send a signal that causes said barrier gate to open and wherein said computer system is configured to send a signal that causes said barrier gate to close.

9. The parking assignment system of claim 1 further comprising a user interface wherein said computer system is in communication with said user interface.

10. The parking assignment system of claim 9 wherein the user interface comprises a speaker and a touchscreen monitor.

11. The parking assignment system of claim 10 wherein said parking assignment device comprises a kiosk and further comprises:
a matrix barcode reader; and
a laser rangefinder;
wherein said touch screen monitor, matrix barcode reader, laser rangefinder, and speaker are in communication with said computer system.

12. The parking assignment system of claim 10 wherein the parking assignment device comprises a parking meter and said computer system receives input from said laser rangefinder that said computer system uses to track available parking spots according to said parking assignment algorithm.

13. The parking assignment system of claim 12 further comprising:
a card reader; and
one or more input devices;
wherein said computer system is in communication with said card reader and said one or more input devices.

14. The parking assignment system of claim 13 wherein said one or more input devices comprise: a matrix code reader.

15. The parking assignment system of claim 13 wherein said one or more input devices comprise a radio-frequency identification card reader.

16. The parking assignment system of claim 1 wherein said sensor comprises a laser rangefinder.

17. The parking assignment system of claim 1 wherein said computer system accepts input that has been transmitted from a user's computing device.

18. The parking assignment system of claim 1 wherein said parking assignment device comprises a parking meter comprising:
a touch screen;
a laser rangefinder mounted on top;
a solar panel mounted above said laser rangefinder, wherein said solar panel provides power to said parking meter;
a matrix code reader;
a card reader; and
a printer.

19. A method of assigning parking spaces using a parking assignment system comprising the following steps:
an automated parking system's computer system receives a parking assignment request from a user;
said automated parking system's computer system receives laser rangefinder input for determining available parking spaces and uses a parking assignment algorithm to determine an optimal available parking spot and assigns the parking spot to the user;
said automated parking device's computer system notifies the user of the assigned parking spot via dispensed ticket, screen notification, or smart device notification;
a smart device application shows the user's vehicle location in the parking lot;
the parking assignment system receives payment from the user; and
the automated parking device's computer system, running software comprising a parking assignment algorithm, registers the vacated parking spot via one or more inputs that may comprise completed payment, vehicle license plate scanning at the exit gate, ticket scanning at exit gate, or laser rangefinder data input from a laser rangefinder that has a view of the parking spot.

20. A method of assigning parking spaces using a parking assignment system comprising the following steps: a computer system running parking assignment software comprising a parking assignment algorithm connects to an automated parking device;
the computer system receives a request for a parking assignment;
the computer system using the parking assignment algorithm receives laser rangefinder data input to determine which parking spaces are unoccupied and determines an optimal available parking spot and assigns the parking spot to a user;
the computer system notifies the user of the assigned parking spot via dispensed ticket at automated parking device, screen notification, or smart device notification;
the computer system receives prepayment or payment for parking lot stay via payment receipt system at automated parking device or via online or smart device application transaction; and
the computer system registers the vacated parking spot via one or more inputs that may comprise: completed payment, vehicle license plate scanning at exit gate, ticket scanning at exit gate, or laser rangefinder distance data input.
